(19) United States
(12) Patent Application Publication
(10) Pub. No.: US 2003/0042795 A1
(43) Pub. Date: Mar. 6, 2003

(54) Electronic device and powerup method

(76) Inventors: Hendricus Joseph Maria Veendrick, Eindhoven (NL); Robert Wiebo Johan Zijlstra, Eindhoven (NL)

Correspondence Address: U.S. Philips Corporation, 580 White Plains Road, Tarrytown, NY, 10591, US

(21) Appl. No.: 10/213,408

(22) Filed: Aug. 6, 2002

(30) Foreign Application Priority Data
Aug. 9, 2001 (EP) 01203031.8

(51) Int. Cl. H02J 1/00

(52) U.S. Cl. 307/38; 365/226

(57) ABSTRACT

An electronic device (100) having n circuit portions (120a, 120b, . . . , 120n) each connected to a supply rail (102) through respective coupling elements (110a, 110b, . . . , 110n) is arranged for gradual self-timed powerup/powerdown of the n circuit portions (120a, 120b, . . . , 120n) under control of control circuit (240a, . . . , 240n−1) to prevent the occurrence of power surges during the powerup of the device (100). When the first circuit portion (120a) has sufficiently been powered up through supply rail (102) and the first coupling element (110a), control circuit (240a) switches second coupling element (110b) to a conductive state, thereby enabling the powerup of second circuit portion (120b). In a similar fashion, the electronic device (100) can be powered down in a gradual self-timed manner through coupling elements (112a, 112b, . . . , 112n), which respectively connect circuit portions (120a, 120b, . . . , 120n) to a further supply rail (104).

The invention relates to an electronic device comprising:

a supply rail;

n circuit portions, n being an integer with minimum value two, including a first circuit portion and a second circuit portion;

coupling means comprising a first coupling element for coupling the first circuit portion to the supply rail;

further coupling means comprising a first further coupling element responsive to a second circuit portion powerup control signal for coupling the second circuit portion to the supply rail a time delay after coupling the first circuit portion to the supply rail.

The invention further relates to a method for powering up a such an electronic device.

U.S. Pat. No. 5,781,490 describes an integrated circuit.

A well-known problem in the semiconductor field is the possible occurrence of large power surges at the start up of an electronic device carrying a plurality of circuit portions. Such an electronic device can be a part of an integrated circuit e.g. an IP core or a memory, an integrated circuit, or a larger device like a printed circuit board (PCB) or a multi-chip module (MCM) carrying a number of smaller electronic devices e.g. integrated circuits. The on- and off-switching of the larger circuit portions of such electronic devices causes large changes in the current consumption, i.e. current peaks, of the electronic device. These current peaks create a large voltage drop (I*R) along the on-chip supply rails as well as supply noise (dI/dt) across the self-inductance of the package leads and bondwires. This will have a dramatic effect on the performance and functionality of that circuit portion. Moreover, since these current peaks are supplied through the package leads and board wires, they can also cause huge electromagnetic radiation causing EMC problems to neighbouring circuit portions. Therefore, the occurrence of these large current peaks can interfere with the modus operandi of the device, or worse, irreversibly damage it.

The aforementioned prior art provides a complementary metal-oxide semiconductor (CMOS) integrated circuit where such power peaks are reduced by dividing the circuit into n circuit portions, with n being at least two, and by switching on the circuit portions in a stepwise fashion. A first powerup control signal enables the powerup of the first circuit portion, whereas the powerup of the next circuit portion is enabled by a second powerup control signal, which is generated a selected time delay after the first powerup control signal is generated. The time delay is generated by a delay stage, which is chosen in such a fashion that the power supply to the circuit has sufficiently recovered from powering the first stage before enabling the powerup of the second circuit portion and so on. This provides relatively safe powerup of the CMOS circuit by reducing the occurrence of the aforementioned power peaks.

A disadvantage of this circuit is that the delay stages have to be controlled by a dedicated control circuit. Apart from the unavoidable associated increase in silicon real estate, this also introduces additional design problems for such circuits, because information about the duration of the powerup of the respective circuit portions has to be taken into consideration to guarantee the sufficient recovery of the power supply. This can be relatively simple for highly regular IC structures, e.g. memories, where the partitioning of the IC can produce n circuit portions of equal size. However, in cases where the IC is of a less regular structure or in cases where powerup timing information is unavailable for the various circuit portions, worst case scenarios have to be embraced to guarantee safe powerup, which can lead to much longer powerup delays than actually required. The latter is increasingly becoming a significant issue, because the art of IC design is more and more turning towards the reuse of large building blocks, e.g. IP cores, DSP cores and so on, which are often designed by and purchased from third parties, in which case detailed information about power dissipation is often lacking. It is a drawback of the known circuit that the way in which the time delay in between the powerup of the various circuit portions is introduced is only guaranteed to be optimal when all relevant timing information regarding the powerup of the various circuit portions is available and taken into consideration.

Accordingly, it is an object of the invention to provide an electronic device of the kind described in the opening paragraph having a minimal effective delay between the powerup steps of its n circuit portions.

It is a further object of the invention to provide a powering-up method with a minimal effective delay between the powerup steps.

Now, the first object of the invention is realized in that the electronic device further comprises a control circuit coupled to the first circuit portion for generating the second circuit portion powerup control signal responsive to a selected powerup state of the first circuit portion.

The further object of the invention is realized in that the method comprises the step of generating the second circuit portion powerup control signal responsive to a selected powerup state of the first circuit portion. Advantageous embodiments are defined by the dependent claims.

The presence of control circuit responsive to a selected powerup state of the first circuit portion, e.g. a predefined value of the internal supply voltage of the circuit portion, provides a self-timed arrangement that switches on the next circuit portion as soon as their predecessor in the switching order is sufficiently charged. This results in a highly efficient and safe gradual powerup arrangement in terms of both cost and powerup duration. This is an important advantage because the control circuit can be kept very simple, and, more importantly, the selected time delay is now solely governed by the size of the circuit portion being powered up, thereby being intrinsically insensitive to the nature of the circuit portions involved. This guarantees a minimized delay interval between the powerup of each circuit portion regardless of its size, which is nevertheless effective in preventing power surges at the powerup of the integrated circuit. As a result, the additional design effort is negligible, thus reducing time-to-market aspects.

By decoupling the first circuit portion from the supply rail with a switchable first coupling element, additional control over the powerup of the integrated circuit can be gained. This allows controlled on/off switching for the whole electronic device, i.e. including the first circuit portion. This is advantageous in arrangements with increased hierarchy, i.e. electronic devices having multiple cores each being subdivided in circuit portions, especially if the cores are connected to the same supply rail. This way, the powerup of the cores can be controlled on an individual basis, in a step-by-step powerup by controlled enabling of the powerup of the various first circuit portions. As a result, some cores can be safely and gradually switched on while other cores are kept in a standby mode, thus providing a very safe power-efficient arrangement.

By extending the coupling means with a second coupling element responsive to a first circuit portion powerdown control signal, gradual off switching of the circuit portions can be initiated as well. This is an important advantage, because the simultaneous off-switching of the n circuit portions can lead to a large dI/dt, which can cause EMC problems in neighbouring devices that are still functionally active.

In addition, extending the control circuit with the ability to generate a powerdown control signal and the further coupling means with a second further coupling element responsive to a second circuit portion powerdown control signal, the whole electronic device can be powered down in a self-timed stepwise fashion with a miminized effective powerdown delay between the various circuit portions, thus leading to an electronic device for which large power surges and dI/dt problems can be avoided in both powerup and powerdown procedures.

A straightforward way of detecting whether the first circuit portion has been sufficiently powered up is by comparing its internally present supply voltage with a, preferably constant, reference voltage in a voltage comparator circuit. Voltage comparators are simple, self-timed logic elements, making them particularly suitable for this application. At the threshold point where the difference between the internal supply voltage and the reference voltage, e.g. the supply voltage, has become sufficiently small, the voltage comparator detects the selected powerup state of the first circuit portion.

In addition, the aforementioned voltage comparator circuit can be extended to detect the powerdown control signal in a similar fashion. This is particularly useful in arrangements where the detrimental effects of both powerup and powerdown have to be avoided.

A very simple implementation of the control circuit is an inverter. Inverters typically consist of two transistors of complementary nature, with the following behaviour: at relatively large differences between an internal supply voltage of a circuit portion and the threshold voltage of one of the transistors, the one transistor becomes enabled, whereas the other transistor becomes disabled. At relatively small differences between these voltages this situation is reversed. The threshold voltage at which one of the transistors becomes enabled can be used as the reference voltage for detecting a powerup control signal. In addition, the threshold voltage at which the other transistor becomes enabled can be used as the threshold voltage to detect a powerdown control signal. In fact, an inverter can be seen as a voltage comparator circuit with very limited area overhead, which is very attractive in terms of cost.

As already mentioned before, the electronic device of the present invention can be a multiple circuit arrangement like a printed circuit board. This is an important advantage, because the building blocks of a printed circuit boards include complete integrated circuits as its circuit portions, with even higher demands on powerup of the printed circuit board than in the case of, for instance, a standalone integrated circuit. By powering up the various circuits of the printed circuit board in a self-timed stepwise fashion, a safe powerup arrangement requiring little additional hardware is achieved. In addition, the present invention is not limited to a single technology only. For instance, the first circuit can be realized in CMOS technology, whereas the second circuit can be realized in bipolar technology. Only the ratio between the voltage portions provided to those circuits and the supply voltage is of importance. Since this ratio is mainly independent from the technology used, the present invention is applicable in a wide variety of technology combinations.

The invention is described in more detail and by way of non-limiting examples with reference to the accompanying drawings, wherein:

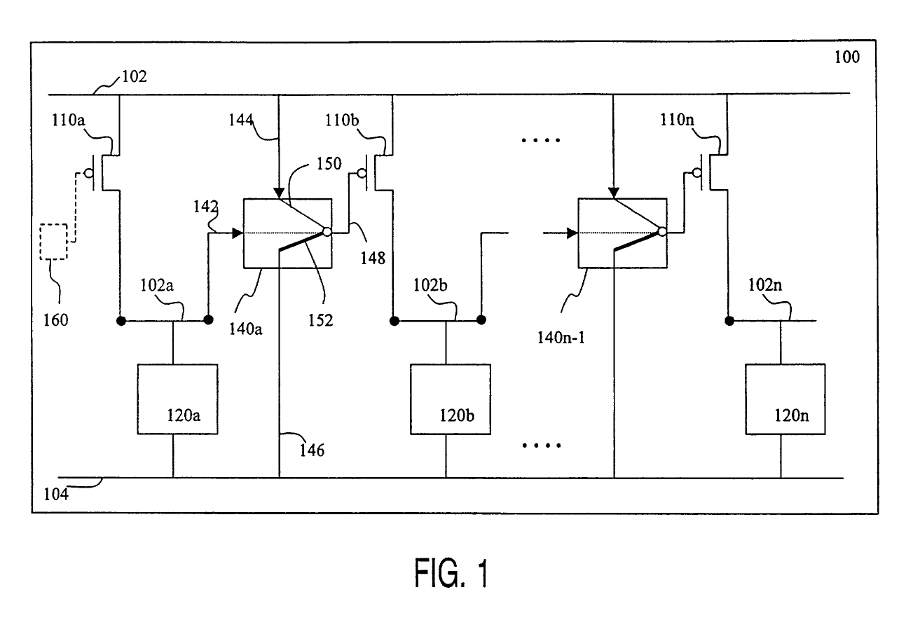

FIG. 1 shows an electronic device according to an embodiment of the present invention,

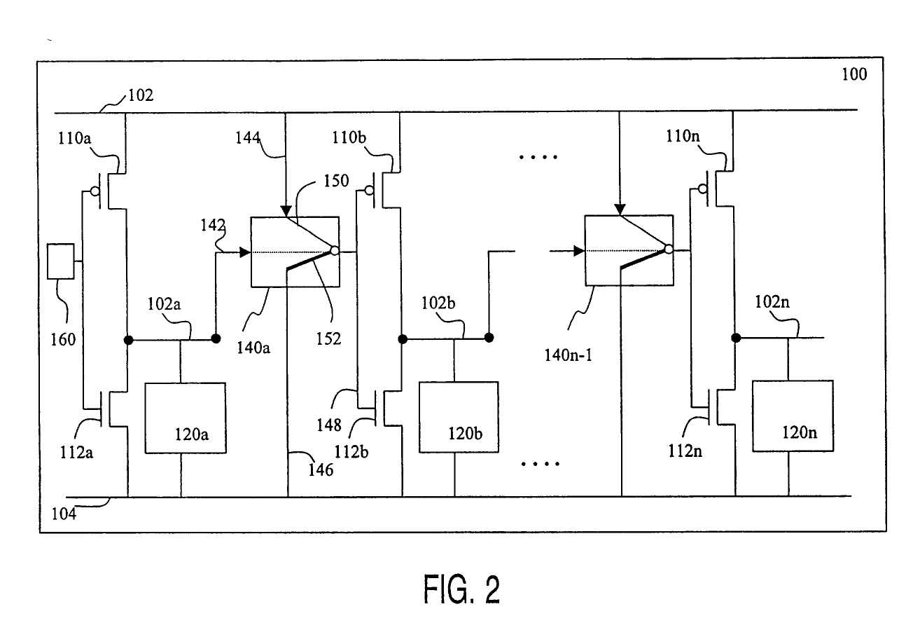

FIG. 2 shows an electronic device according to another embodiment of the present invention, and

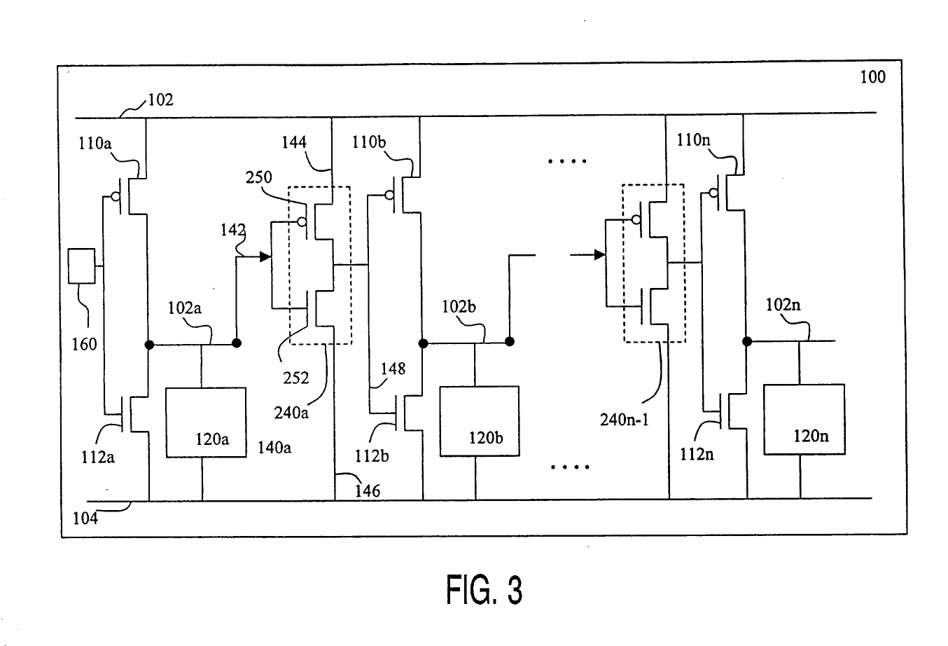

FIG. 3 shows an electronic device according to yet another embodiment of the present invention.

The electronic device 100 in FIG. 1 may be coupled to a power supply not shown through supply rail 102. The electronic device has n circuit portions, with n being an integer with a value of at least two. Inter alia, the electronic device can be a part of an integrated circuit, an integrated circuit, a printed circuit board or a multi chip module. A first circuit portion 120a is coupled to supply rail 102 through a first coupling element 110a and an internal first circuit portion supply rail 102a, whereas a second circuit portion 120b is coupled to supply rail 102 through a second coupling element 110b and an internal second circuit portion supply rail 102b. First coupling element 110a can be as simple as a resistor not shown or, preferably, a transistor responsive to further control circuit 160, as depicted in FIG. 1. Obviously, when a resistor is used in order to introduce a voltage drop between supply rail 102 and internal first circuit portion supply rail 102a further control circuit 160 is redundant and can be omitted from the arrangement. It is emphasized that first coupling element 110a can even be a permanent conductor e.g. a wire. However, in that case circuit portion 120a and 120b will start powering up simultaneously, in which case they can be regarded as a combined single circuit portion.

Second coupling element 110b is responsive to control circuit 140a, which couples second coupling element 110b to circuit portion 120a through a connector 142 and a connector 148. Connectors 142 and 148 are typically connective elements known from the art. Here, second coupling element 110b is a pMOS transistor, with connector 148 coupling the output of the control circuit 140a to the gate of second coupling element 110b. More particularly, for instances in cases where low power consumption is an issue, second coupling element 110b is a high threshold voltage pMOS transistor that reduces the current leakages from second circuit portion 120b in standby and is capable of coping with the power demand of second circuit portion 120b. Obviously, the same holds for first coupling element 110a; this can also be a high voltage pMOS threshold transistor. It is emphasized that to a person skilled in the art many other equivalents of coupling elements 110a and 110b are readily available. In addition, control circuit 140a is connected to the supply rail 102 by a connector 144 and to a further supply rail 104 by a connector 146. Again, connectors 144 and 146 are typically connective elements known from the art. It is stipulated that this arrangement can be extended to n circuit portions, as emphasized by the presence of circuit portion 120n in FIG. 1. In this case, second circuit portion 120b is coupled to a next voltage comparator circuit not shown and so on, up until circuit portion 120n, which is coupled to the supply rail 102 through coupling element 110n. Coupling element 110n is coupled to circuit portion 120n−1 not shown through a further control circuit 140n−1. This way, a self-timed, daisy chain-like arrangement of n circuit portions each being powered up responsive to its predecessor, with the obvious exception of n=1, is obtained.

In operation, the powerup of electronic device 100 as shown in FIG. 1 takes place as follows. A supply voltage is applied to supply rail 102. First coupling element 110a is either intrinsically relatively conductive or is switched to a conductive state under control of further control circuit 160. As a result, first circuit portion 120a is being powered up. The in FIG. 1 depicted embodiment of control circuit 140a, may be formed by a voltage comparator circuit 140a, which detects the powerup of first circuit portion 120a by monitoring the ratio of the supply voltage provided to the control circuit 140a through connector 144 and the internal supply voltage of first circuit portion 120a which is obtained from the internal first circuit portion supply rail 102a and provided to the control circuit 140a through connector 142. When this ratio is large, i.e. first circuit portion 120a has not reached its selected powerup state yet, voltage comparator circuit 140a couples connector 148 to supply rail 102 carrying a relatively high voltage through conductive path 150 and connector 144. The gate of coupling element 110b is pulled up as a result, and coupling element 110b is captured in a nonconductive state, thus decoupling second circuit portion 120b from the supply rail 102. However, when the ratio becomes small enough, i.e. first circuit portion 120a has become sufficiently powered up and has reached its selected powerup state, voltage comparator circuit 140a switches from conductive path 150 to conductive path 152, now coupling connector 148 to connector 146. As a result, the gate of second coupling element 110b is now connected to further supply rail 104 carrying a relatively low voltage and subsequently pulled down, and switching element 110b becomes conductive, thus enabling the powerup of second circuit portion 120b. In short, the voltage comparator circuit 140a is sensitive to the voltage provided via conductor 142, as indicated by the dashed line from conductor 142 to the switch of voltage comparator 140a in FIG. 1. It should be obvious to anyone skilled in the art that the gradual powerup of integrated circuit 100 as described here can be readily extended to n circuit portions. In addition, it is emphasized that when realizing the invention in CMOS technology, the complementary nature of CMOS allows realization of the invention in both complements of the technology. For instance, supply rail 102 can be the Vdd rail and further supply rail 104 can be the Vss rail with coupling elements 110a, 110b, . . . 110n being pMOS transistors and further coupling elements 112a, 112b, . . . , 112n being nMOS transistors and so on, but the complementary arrangement, with supply rail 102 being the Vss rail and further supply rail 104 being the Vdd rail with coupling elements 110a, 110b, . . . 110n being nMOS transistors and further coupling elements 112a, 112b, . . . , 112n being pMOS transistors, is equally acceptable without departing from the scope of the invention.

The alternative embodiment of electronic device 100 in FIG. 2 is now described referring back to the detailed description of FIG. 1. Reference numerals used in FIG. 1 have corresponding meanings in FIG. 2. In FIG. 2, the electronic device shown in FIG. 1 is extended with an arrangement to enable self-timed gradual powerdown preferably with a minimal effective time delay. The electronic device depicted in FIG. 2 is a preferrable arrangement, because large dI/dt effects can also occur during powerdown. In FIG. 2, electronic device 100 has been extended with a second coupling element 112a responsive to further control circuitry 160 for coupling the first circuit portion 120a to further supply rail 104 through its internal first circuit portion supply rail 102a. In addition, a second further coupling element 112b responsive to control circuit 140a couples the second circuit portion 120b to further supply rail 104 through its internal second circuit portion supply rail 102b. Typically, in CMOS technology supply rail 102 is the Vdd rail whereas further supply rail 104 is the Vss rail, although the complementary nature of CMOS allows for an alternate implementation of supply rails 102 and 104 as well. The second coupling elements 112a and 112b enable the fast powerdown of circuit portions 120a and 120b respectively by supplying a conductive path for the charges stored in circuit portions 120a and 120b to leak away to the ground e.g. further supply rail 104. Because second further coupling element 112b is responsive to a powerdown control signal generated by control circuit 140a, the powerdown of second circuit portion 120b is only then enabled when first circuit portion 120a has reached a selected powerdown state. This way, the powerdown of the electronic device 100 can be realized without having to switch of the main power supply through supply rail 102 to the various circuit portions 120a, 120b, . . . , 120n, thus avoiding large dI/dt effects. It is emphasized that further coupling elements 112a, 112b, . . . , 112n may be very small nMOS transistors because they do not have to facilitate the power supply to the respective circuit portions 120a, 120b, . . . , 120n during operation of these circuit portions. This is very advantageous in terms of silicon real estate. The accompanying disadvantage is that the powerdown of the associated circuit portions 120a, 120b, . . . , 120n becomes slower than when using larger coupling elements 112a, 112b, . . . , 112n. This is, however, a negligible disadvantage because this will typically shift powerdown times into the low regions of the millisecond domain, which is still fast enough for most applications where putting parts of an electronic device 100 in a standby mode is a relevant issue.

The operation of the electronic device 100 depicted in FIG. 2 is now described in more detail. Again, as an embodiment of control circuit 140a a voltage comparator circuit 140a will be used, even though it should be obvious to those skilled in the art that other equivalent embodiments of control circuit 140 can be applied without departing from the scope of the invention. When electronic device 100 is in a powered down state, second control switch 112a as well as second further control switch 112b will be switched to a conductive state, whereas control switches 110a and 110b will both be switched to a nonconductive state. Therefore, even if supply rail 102 carries a high voltage, circuit portions 120a and 120b will be only connected to ground e.g. further supply rail 104 and will therefore remain in a powered down state. Now, when further control circuit 160 generates a first circuit portion powerup control signal, coupling element 110a is switched to a conductive state. Approximately simultaneously, second coupling element 112a is switched to a nonconductive state in order to allow the powerup of first circuit portion 120a and to prevent a short-circuit between supply rail 102 and further supply rail 104. When first circuit portion is sufficiently powered up, i.e. reaches a selected powerup state, voltage comparator circuit 140a generates a second circuit portion powerup control signal by switching its conductive path 150 to conductive path 152, as previously described. As a result, further coupling element 110b is switched to a conductive state. Approximately simultaneously, second further coupling element 112b is switched to a nonconductive state in order to allow the powerup of second circuit portion 120b and to prevent a short-circuit between supply rail 102 and further supply rail 104. When electronic device 100 is fully operational, i.e. all circuit portions 120a, 120b, . . . , 120n are powered up, the electronic device 100 can be gradually switched off in the following manner. When further control circuit 160 generates a first circuit portion powerdown control signal, coupling element 110a is switched to a nonconductive state. Approximately simultaneously, second coupling element 112a is switched to a conductive state in order to allow the powerdown of first circuit portion 120a. The first circuit portion powerdown control signal can simply be the negation of the first circuit portion powerup control signal. When first circuit portion is sufficiently powered down, i.e. reaches a selected powerdown state, voltage comparator circuit 140a generates a second circuit portion powerdown control signal by switching its conductive path 152 to conductive path 150, effectively switching from a low voltage to a high voltage. As a result, further coupling element 110b is switched to a nonconductive state. Simultaneously, second further coupling element 112b is switched to a conductive state in order to allow the powerdown of second circuit portion 120b. The selected powerup and powerdown states can simply be defined as a circuit portion 120a, 120b, . . . 120n−1 reaching a voltage respectively lying above and below the same voltage threshold, respectively. Alternatively, the selected powerup state can be defined as a circuit portion 120a, 120b, . . . 120n−1 reaching a voltage above a first voltage threshold, whereas the selected powerdown state can be defined as a circuit portion 120a, 120b, . . . 120n−1 reaching a voltage below a second voltage threshold, with the first voltage threshold being larger than the second voltage threshold. In the latter case, a hysteresis effect in the gradual self-timed on/off switching of the circuit portions 120b, . . . , 120n is present. It should be well-known to anyone skilled in the art that such hysteresis effects can be readily implemented by voltage comparators.

FIG. 3 depicts an alternative embodiment of the circuit shown in FIG. 2. Reference numerals used in FIG. 2 have corresponding meanings in FIG. 3. Here, control circuit 240a e.g. an inverter 240a is a very simple alternative to the voltage comparator circuit 140a shown in FIG. 2. Inverter 240a has a first transistor 250 coupled in series with a second transistor 252, first transistor 250 being a pMOS transistor and second transistor 252 being a nMOS transistor. The control terminals, i.e. gates, of transistors 250 and 252 are coupled to first circuit portion 120a through connector 142. The dimensions of transistors 250 and 252 are chosen such that first transistor 250 is switched on when first circuit portion 120a has not reached its selected powerup level yet, i.e. the internal supply voltage of first circuit portion 120a is smaller than the threshold voltage to switch on second transistor 252. Due to the complementary nature of CMOS, first transistor 250 is switched on while second transistor 252 is switched off, pulling the gate of second coupling element 110b up by connecting it to supply rail 102 through connectors 144 and 148. In other words, transistor 250 operates as conductive path 150 in FIG. 2. On reaching its selected powerup state, first circuit portion 120a enables transistor 252 as well as disables transistor 250 through connector 142. This generates the second circuit portion powerup control signal; the gate of second coupling element 110b is pulled down, because transistor 252 operates as conductive path 152 in FIG. 2, coupling the gate of second coupling element 110b to further supply rail 104 through connectors 146 and 148. As a result, second coupling element 110b becomes conductive while approximately simultaneously with the second further coupling element 112b becoming nonconductive, and the powerup of second circuit portion 120b is initiated. The second circuit portion powerdown control signal is generated by the inverse of this mechanism; when circuit portion 120a reaches a selected powerdown state, first transistor 250 is switched on and second transistor 252 is switched off. Now, inverter 240a operates as conductive path 150 in FIG. 2 and generates the second circuit portion powerdown signal accordingly.

At this point it is emphasized that although the embodiments of the inventions are described in terms of CMOS technology, the realization of the self-timed gradual powerup arrangements like control circuit 140a and control circuit 240a, is not limited to CMOS technology only. Other technologies that are not explicitly shown here, e.g. bipolar technology, can be used as well to realize such circuits without departing from the scope of the invention. Moreover, an important aspect of the teachings of the present invention is that the powerup of a circuit portion 120b is governed by a technology independent parameter, i.e. a supply voltage from a previous circuit portion 120a. Therefore, there is no technological limitation to apply a plurality of circuits realized in various technologies on an electronic device 100 being a printed circuit board or a multi chip module. For instance, first circuit portion 120a can be realized in a first technology e.g. CMOS and second circuit portion 120b can be realized in a second technology e.g. bipolar with still being able to powerup the various circuits in a self-timed stepwise fashion. Control circuit 140a can either be integrated in first circuit portion 120a or in second circuit portion 120b, or it can be realized outside these circuits on the printed circuit board or the multi chip module.

A safe powerup scheme for devices like integrated circuits and printed circuit boards, which is of particular relevance to the lifetimes of these devices if they have to be powered up numerous times, is provided by the method according to the present invention. In a first step, powering up the first circuit portion brings the first part, or circuit portion of the device into a powered up state. In a second step, generating a powerup control signal responsive to a selected powerup state of the first circuit portion a selected time delay after powering up the first circuit portion guarantees that the powerup control signal enabling the powerup of a next part, or circuit portion of the device is generated as soon as the previous part is sufficiently powered up as defined by a selected powerup state of the first circuit portion. This guarantees that the second circuit portion will only then be powered up when the power supply is capable of dealing with the power demand of the second circuit portion. Then, in a final step, powering up the second circuit portion responsive to the powerup control signal is realized. The method thus guarantees a self-timed, minimal time delayed stepwise powerup of the intended devices, which provides a low cost manner to extend device lifetimes.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An electronic device (100) comprising:
a supply rail (102);
n circuit portions (120a, 120b, 120n), n being an integer with minimum value two, including at least a first circuit portion (120a) and a second circuit portion (120b);
coupling means (110a, 112a) comprising a first coupling element (110a) for coupling the first circuit portion (120a) to the supply rail (102); and
further coupling means (110b, 112b) comprising a first further coupling element (110b) responsive to a second circuit portion powerup control signal for coupling the second circuit portion (120b) to the supply rail (102) a time delay after coupling the first circuit portion (120a) to the supply rail (102),
characterized by further comprising:
a control circuit (140a; 240a) coupled to the first circuit portion (120a) for generating the second circuit portion powerup control signal responsive to a selected powerup state of the first circuit portion (120a).

2. An electronic device (100) as claimed in claim 1, characterized by further comprising:
a further control circuit (160) for generating a first circuit portion powerup control signal, the first coupling element (110a) being switchable to a conductive state responsive to the first circuit portion powerup control signal.

3. An electronic device (100) as claimed in claim 2, characterized in that:
the further control circuit (160) is arranged for generating a first circuit portion powerdown control signal; and
the coupling means comprises a second coupling element (112a) for coupling the first circuit portion (120a) to a further supply rail (104) responsive to the first circuit portion powerdown control signal.

4. An electronic device (100) as claimed in claim 3, characterized in that:
the control circuit (140a, 240a) is arranged for generating a second circuit portion powerdown control signal responsive to a selected powerdown state of the first circuit portion (120a); and
the further coupling means (110b, 112b) comprises a second further coupling element (112b) for coupling the second circuit portion (120b) to the further supply rail (104) responsive to the second circuit portion powerdown control signal.

5. An electronic device (100) as claimed in claim 1 or 2, characterized in that the control circuit (140a) comprises a voltage comparator circuit (140a)
for detecting the selected powerup state by comparing an internal supply voltage of the first circuit portion (120a) with a reference voltage,
to generate the second circuit portion powerup control signal responsive to the detection of the selected powerup state.

6. An electronic device as claimed in claim 4, characterized in that the control circuit (140a) comprises a voltage comparator circuit (140a)
for detecting the selected powerup state by comparing an internal supply voltage of the first circuit portion (120a) with a reference voltage,
to generate the second circuit portion powerup control signal responsive to the detection of the selected powerup state and
for detecting the selected powerdown state by comparing the internal supply voltage of the first circuit portion (120a) with the reference voltage,
to generate the second circuit portion powerdown control signal responsive to the detection of the selected powerdown state.

7. An electronic device (100) as claimed in claim 5 or 6, characterized in that the reference voltage is a supply voltage.

8. An electronic device (100) as claimed in claim 1, characterized in that the voltage comparator circuit (240a) comprises an inverter (240a) comprising a first transistor (250) and a second transistor (252), each having a control terminal being responsive to an internal supply voltage of the first circuit portion (120a).

9. An electronic device (100) as claimed in claim 8, characterized in that:
the selected powerup state is governed by a first dimension of the first transistor (250) and a second dimension of the second transistor (252).

10. An electronic device (100) as claimed in claim 1, characterized in that the first circuit portion (120a) is realized in a first technology, and the second circuit portion (120b) is realized in a second technology.

11. A method for powering up an electronic device (100) comprising n circuit portions including a first circuit portion (120a) and a second circuit portion (120b), the method comprising:
powering up the first circuit portion (120a);
generating a powerup control signal a time delay after powering up the first circuit portion (120a); and
powering up the second circuit portion (120b) responsive to the powerup control signal,
characterized by:
generating the powerup control signal responsive to a selected powerup state of the first circuit portion (120a).
